(19) United States
(12) Patent Application Publication
(10) Pub. No.: US 2025/0320094 A1
(43) Pub. Date: Oct. 16, 2025

(54) UNDERFLOOR LIFTING PLATFORM FOR LIFTING VEHICLES AND A METHOD FOR PRODUCING AN UNDERFLOOR LIFTING PLATFORM FOR LIFTING VEHICLES

(71) Applicant: AUTOPSTENHOJ GMBH, Rheine (DE)

(72) Inventor: WOLFGANG NABER, Neuenkirchen (DE)

(21) Appl. No.: 19/176,533

(22) Filed: Apr. 11, 2025

(30) Foreign Application Priority Data
Apr. 15, 2024 (EP) 24170186.1

(51) Int. Cl. B66F 7/20; B66F 7/28

(52) U.S. Cl. CPC B66F 7/20; B66F 7/28

(57) ABSTRACT

An underfloor lifting platform (1) for lifting vehicles comprises: a canister (200), configured to be arranged underground to define an inground environment; a plate (300), couplable with the canister (200) so to close the inground environment and to be flush with the floor (F); a first and a second cylinder piston units (400A, 400B), operatively arranged within the canister (200) and being movable along a vertical direction (V), wherein the canister (200) includes: a body (20), surrounding the inground environment, extending in the vertical direction (V) between a first edge (20A), proximal to the plate (300), and a second edge (20B), opposite to the first edge (20A), and defining a supporting surface for supporting the plate (300); a frame (22), made of stainless steel, connected to the body (20) at the first edge (20A) of the body (20), the frame (22) having an outer perimeter that is flush with the floor (F) and surrounds the plate (300), the frame (22) is removably connected to the body (20) through a plug system (23).

### FIELD OF THE INVENTION

This invention relates to an underfloor lifting platform for lifting vehicles and to a method for producing an underfloor lifting platform for lifting vehicles.

### BACKGROUND OF THE INVENTION

Lifting devices are commonly employed for lifting motor vehicles during maintenance procedures. These devices typically comprise an underground cassette or canister, which encloses an inground space that houses two lifting cylinders, for lifting the vehicle along a vertical direction.

The inground space is covered from the outside by a plate, leaving some portions of the canister visible externally. Therefore, it is preferable for these visible components to be made of stainless steel, to ensure robustness against wearing and aesthetic appeal. However, constructing the entire canister from stainless steel can be very expensive.

Document DE202014006080U1 offers a solution to the issue of canister wear; however, the resulting design is complicated and costly in terms of production. Moreover, this solution is expensive to transport and difficult to install.

Hence, there is still the need for a canister that is robust against wearing, while being simpler and more cost-effective to maintain and to manufacture.

Documents EP2246502A2 and DE20013746U1 also provide examples of underfloor lifting platforms; however, neither of them offers a solution that meets the market's needs.

### BRIEF SUMMARY OF THE INVENTION

Scope of the present invention is to overcome at least one of the aforementioned drawbacks.

This scope is achieved by the underfloor lifting platform for lifting vehicles and by the method for producing an underfloor lifting platform for lifting vehicles, according to the appended claims.

In particular, the underfloor lifting platform for lifting vehicles comprises a canister, configured to be arranged underground to define an inground environment.

The underfloor lifting platform comprises a plate. The plate is couplable with the canister so to close the inground environment. The plate is flush with the floor.

The underfloor lifting platform comprises a first and a second cylinder piston units, operatively arranged within the canister (that is, when the canister is closed, the first and the second cylinder piston units are enclosed in the inground environment). The first and the second cylinder are movable along a vertical direction. The first and the second cylinder are movable along the vertical direction so to lift the vehicles along the vertical direction.

The canister includes a body, surrounding the inground environment. The body extends in the vertical direction between a first edge and a second edge, opposite to the first edge. The first edge is proximal to the plate. The body defines a supporting surface configured for supporting the plate. In particular, the supporting surface is interposed, along the vertical direction, between the first edge and the second edge. Preferably, the first edge develops along a horizontal direction perpendicular to the vertical direction. In particular, the first cylinder piston unit and the second cylinder piston unit are aligned with each other in the horizontal direction.

Preferably, the supporting surface develops along a horizontal direction perpendicular to the vertical direction. The first edge and the supporting surface can lay on a same extension plane oriented along the horizontal direction.

The canister includes a frame, connected to the body. The frame is connected to the body at the first edge. The frame has an outer perimeter that is flush with the floor and surrounds the plate. In particular, the frame and the body connected together at the first edge define a contact surface that lay on a plane that is perpendicular to the vertical direction.

Preferably, the frame extends (exclusively) along an extension plane parallel to the vertical direction. The frame defines a straight profile. The underfloor lifting platform is characterized in that the frame is removably connected to the body through a plug system. Hence, the frame and the body together define a pluggable system. The part that are visible externally (i.e. the outer perimeter of the frame) are stainless steel so to ensure both durability and aesthetic appeal; as the frame is connected to the body via a plug system, the body can potentially be made from or comprise any material. Additionally, the plug system avoids the need for welding between the stainless steel frame and the body. Also, it is noted that welding galvanized components is problematic because it does not allow the components to stay straight.

Moreover, the solution allows to optimize transport spaces and simplifies the installation because lighter pieces are moved around rather than the whole assembly. In addition, the fact that there the components are plugged together allows for simple and quick assembly of the components.

Preferably, the body comprises a layer of hot-dip galvanized material. The hot-dip galvanization of the body is used to enhance protection against corrosion and general wear of the cassette. The hot-dip galvanized layer tends to deteriorate when welding. However, as the body is hot-dip galvanized and then plugged to the frame, there is no risk to damage the hot-dip galvanized layer.

The layer of hot-dip galvanized material has a thickness of at least 50 micron (50 μm); preferably, the thickness of the layer of hot-dip galvanized material is lower than 150 micron (150 μm).

In particular, the plug system includes a plurality of connecting protrusions and a plurality of corresponding connecting holes, configured for engaging with each other so to connect the body and the frame together. When connecting the frame and the body together, a connecting protrusion enters in a connecting hole. In an example, each connecting protrusion (or a group of connecting protrusions) of the plurality of connecting protrusions is hook-shaped. The plug system can have a plurality of pins. Each pin is configured to engage with the hole of a corresponding connecting protrusion so to block the frame and the body together when the connecting protrusion is inserted in the corresponding connecting hole. Hence, the pin can engage with the hole of a connecting protrusion, wherein the connecting protrusion can be hook-shaped (or not necessarily). The connecting protrusions can be provided at the frame and the connecting holes can be provided at the body and/or vice versa.

The body includes a pair of sidewalls. The sidewalls extend along a horizontal direction perpendicular to the vertical direction. The sidewalls of the pair of sidewalls are opposite to each other. The frame includes a pair of panels. The panels of the pair of panels are opposite to each other. The panels of the pair of panels are connected to the pair of sidewalls of the body so to define, together with the pair of sidewalls, a rectangular shaped-box. In particular, the panels and the sidewalls are connected together by shape coupling. Preferably, the panels and the sidewalls are connected together through the plug system.

The frame includes a pair of elongated portions. The elongated portions of the pair extend along a horizontal direction perpendicular to the vertical direction. Each elongated portions of the pair of elongated portions are connected at the first edge of the body with a respective sidewall of the pair of sidewalls of the body. Hence, the first edge is provided in the sidewalls of the body. Moreover, the pair of elongated portions are connected to the pair of panels so that the outer perimeter of the frame is defined by the pair of elongated portions and by the pair of panels flush with the floor. In particular, each pair of panels has an edge that is flush with the floor and each of the elongated portions has an edge that is flush with the floor. The edge of the panels, together with the edge of the elongated portions, define the outer perimeter of the frame. The panels have a height defined along the vertical direction that is larger with respect to the height of the elongated portion. In particular, the elongated portions of the frame and the sidewalls of the body have, together, substantially the same height of the height of the panels.

In an embodiment, each of the sidewalls develops from the first edge to the second edge so to define a bended profile. In particular, the bended profile has a first portion protruding towards a central area (i.e. the inground environment) of the body, along a horizontal direction perpendicular to the vertical direction. The first portion defines the supporting surface for the plate. Hence, when the plate is coupled with the canister, the plate abuts at the first portion of the supporting surface. The first portion is connected to the first edge of the body; both the first edge and the first portion lay along a horizontal direction perpendicular to the vertical direction. Moreover, the bended profile has a second portion protruding from the first portion along the vertical direction towards the second edge. In other words, the second portion is connected to the first portion and extends in the vertical direction towards the second edge. The bended profile can have a third portion, protruding from the second portion along the horizontal direction, away from a central area of the body. The third portion is parallel to the first portion.

Preferably, the frame (the elongated portions and/or the panels of the frame) has a thickness defined perpendicular to the vertical direction of at least 4 mm.

In an embodiment, the underfloor lifting platform comprises a gasket. The gasket is configured for sealing a gap between the plate and the frame. In particular, the gasket is in contact with the frame and with a surface of the plate facing the frame, so to seal a gap between the plate and the frame.

Hence, the inground environment is airtight with the outside. Preferably, the gasket is configured for sealing a gap between the elongated portions of the frame and the plate and a gap between the panels of the frame and the plate. Preferably, the gasket has a rectangular shape (i.e. the gasket runs along a perimeter of the plate). In an example, the plate has a recess which runs along a perimeter of the plate and is configured for receiving a portion of the gasket so that the gasket, inserted in the recess and in contact with the frame, is configured for sealing a gap between the plate and the frame.

In an example, the canister includes a first strip and a second strip, located between the plate and the supporting surface (i.e. the first portion) of the body. The first strip is located between the plate and the first portion of the first sidewall of the body, while the second strip is located between the plate and the first portion of the second sidewall of the body. The first strip and the second strip can be configured for sealing a gap between the plate (the central plate) and the first portions (or for distancing the plate, that is the central plate, and the first portions). The first strip and the second strip can be made of a plastic material (in particular, of polyethylene PEHD).

It is also an object of the present disclosure a method for producing an underfloor lifting platform for lifting vehicles.

The method comprises a step of providing a canister, arranged underground to define an inground environment. The method comprises a step of providing a plate, coupled to the canister so to close the inground environment. The plate is coupled to the canister flush with the floor. The method comprises a step of providing a first and a second cylinder piston unit. The first and the second cylinder piston units are operatively arranged within the canister. The first and the second cylinder piston units are movable along a vertical direction.

The method comprises a step of providing a body for the canister (in other words, the step of providing a canister includes providing a body of the canister), surrounding the inground environment. The body extends in the vertical direction between a first edge, proximal to the plate, and a second edge, opposite to the first edge. The body defines a supporting surface for supporting the plate.

The method comprises a step of providing a frame, made of stainless steel. The method comprises a step of connecting the frame to the body at the first edge of the body. The frame has an outer perimeter that is flush with the floor and surrounds the plate. The frame is removably connected the body through a plug system. In other words, the method comprises a step of removably connecting the frame and the body through a plug system.

In an example, the plate is aluminum extruded.

Preferably, the method comprises a step of dipping the body with a layer of galvanized material. In particular, the step of dipping the body with the layer of galvanized material is completed before connecting the frame to the body.

In particular, the plug system includes a plurality of connecting protrusions and a plurality of corresponding connecting holes configured for engaging with each other so to connect the body and the frame together. In an example, each connecting protrusion (or a group of connecting protrusions) of the plurality of connecting protrusions is hook-shaped. The plug system can have a plurality of pins, each configured to engage with the hole of a corresponding connecting protrusion so to block the frame and the body together when the connecting protrusion is inserted in the corresponding connecting holes. In other words, the step of connecting the frame to the body includes inserting the connecting protrusion in a corresponding connecting hole and blocking the frame and the body together by inserting a pin in a hole of the connecting protrusion.

The body includes a pair of sidewalls. The sidewalls extend along a horizontal direction perpendicular to the vertical direction. The sidewalls are opposite to each other. The frame includes a pair of panels. The panels are opposite to each other. The method comprises a step of removably connecting the pair of panels to the pair of sidewalls of the body, so to define, together with the pair of sidewalls, a rectangular shaped-box. In particular, the panels and the sidewalls are connected together by shape coupling. Preferably, the panels and the sidewalls are connected together through the plug system. In other words, the step of connecting the frame and the body together includes a step of connecting the pair of panels with the pair of sidewalls by shape coupling.

The frame includes a pair of elongated portions, extending along a horizontal direction perpendicular to the vertical direction. The method may comprise a step of connecting each elongated portions of the pair of elongated portions with a respective sidewall of the pair of sidewalls of the body. The method may comprise a step of connecting the pair of elongated portions to the pair of panels so that the outer perimeter is defined by the pair of long portions and the pair of panels flush with the floor.

In an embodiment, each of the sidewalls develops from the first edge to the second edge so to define a bended profile. In particular, the bended profile has a first portion protruding towards a central area of the body along a horizontal direction perpendicular to the vertical direction. The first portion defines the supporting surface for the plate. The first portion can be welded to the second portion. In other words, the method comprises a step of welding the first portion to the second portion. Preferably, the step of welding the first portion to the second portion is completed before step of hot dipping the body with a galvanized material.

In an embodiment, the method comprises a step of sealing a gap between the plate and the frame through a gasket. The gasket is in contact with the frame and with a surface of the plate facing the frame. In an example, the plate has a recess which runs along a perimeter of the plate. The step of sealing the gap may include receiving a portion of the gasket by the recess of the plate so that the gasket, inserted in the recess and in contact with the frame, seals a gap between the plate and the frame.

### BRIEF DESCRIPTION OF THE DRAWINGS

This and other features of the invention will become more apparent from the following detailed description of a preferred, non-limiting example embodiment of it, with reference to the accompanying drawings, in which:

FIGS. 1A and 1B illustrate a portion of a canister assembled and exploded, according to one or more aspects of the present invention;

FIG. 1C illustrates an exploded view of a portion of a canister coupled with a plate, according to one or more aspects of the present invention;

FIGS. 2A and 2B illustrate a section of an underfloor lifting platform according to one or more aspects of the present invention;

FIGS. 3A and 3B illustrate a portion of a canister according to one or more aspects of the present invention;

FIGS. 4A and 4B illustrate an underfloor lifting platform according to one or more aspects of the present invention.

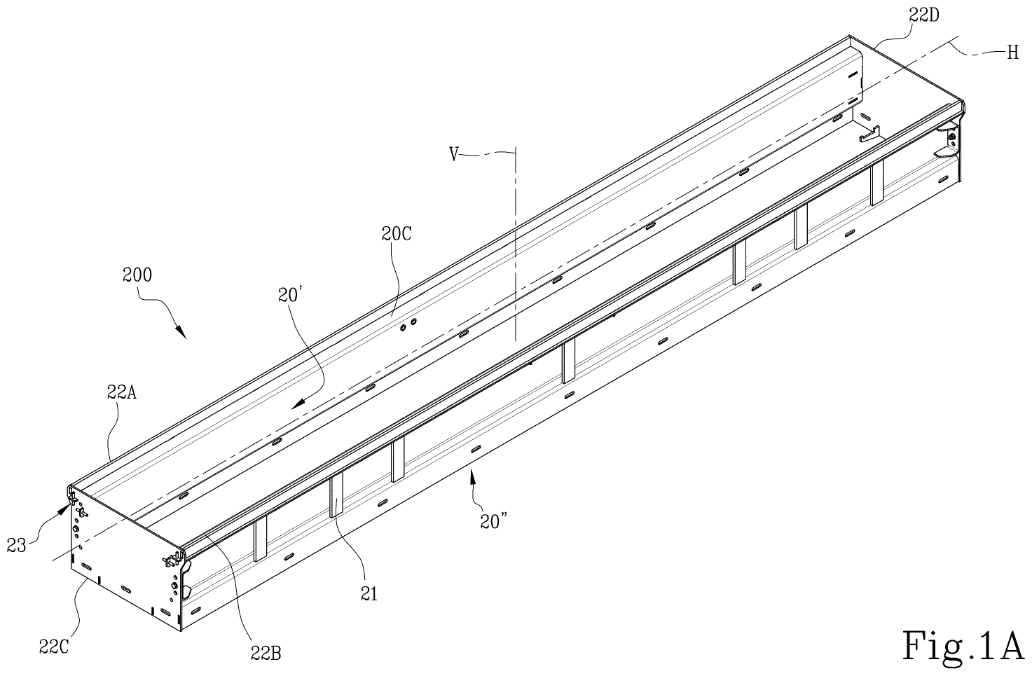

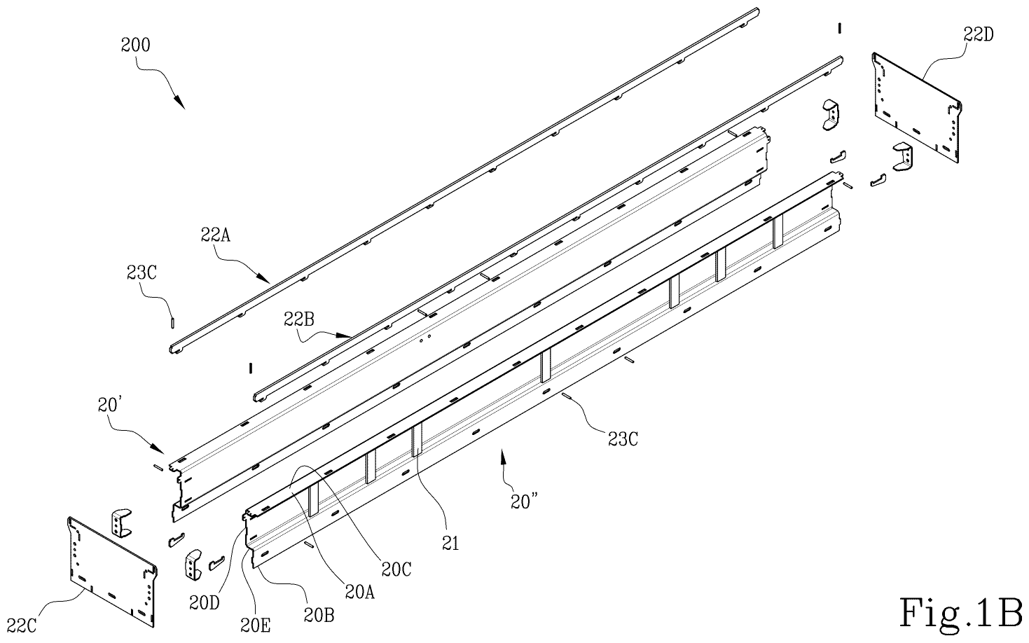

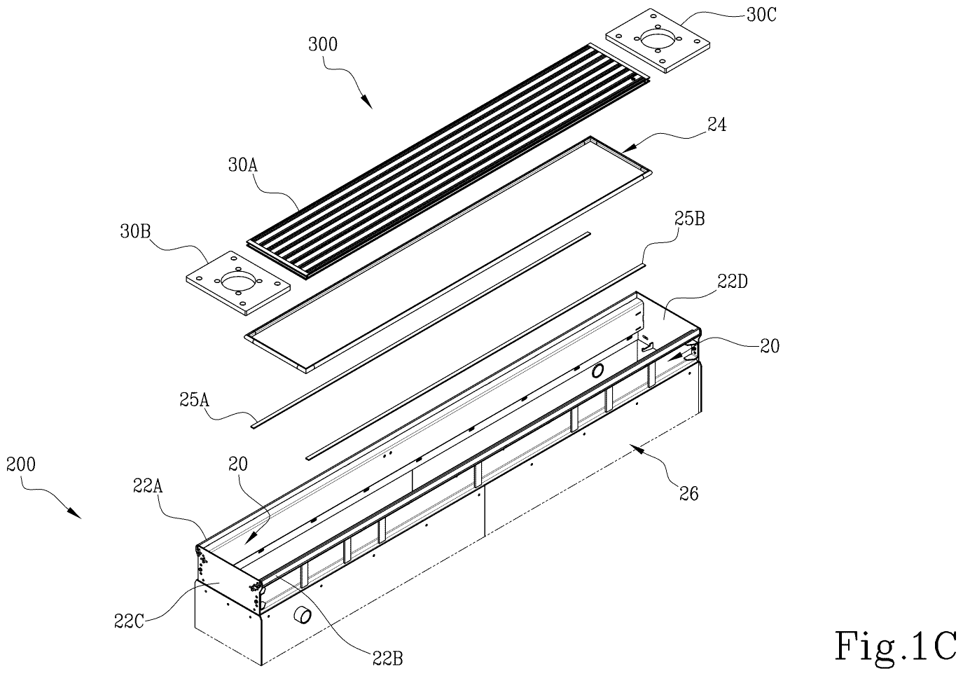

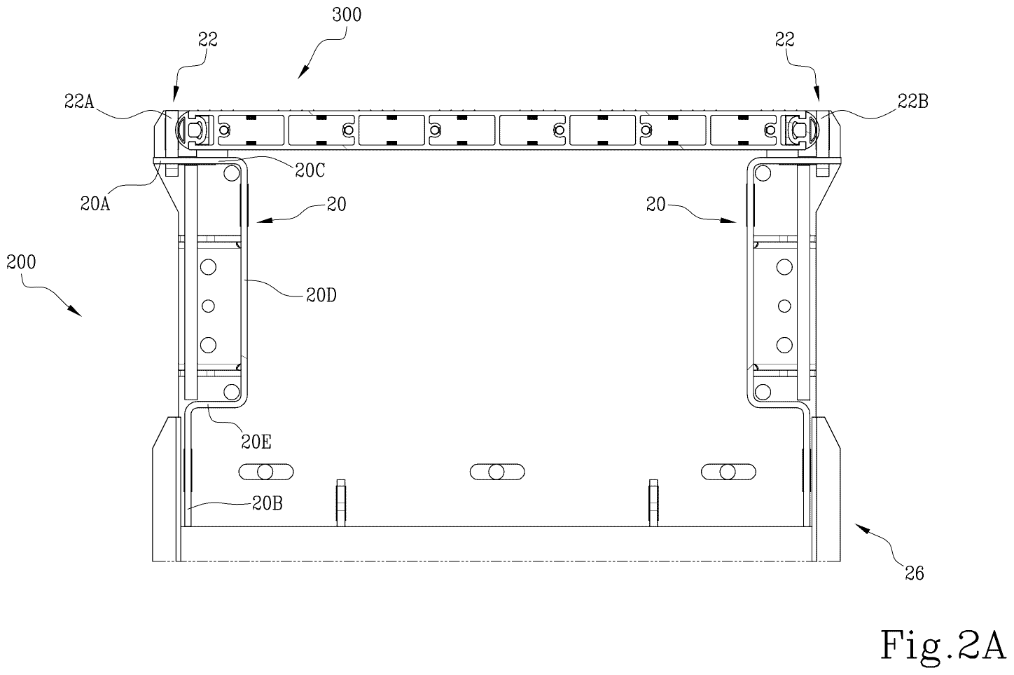

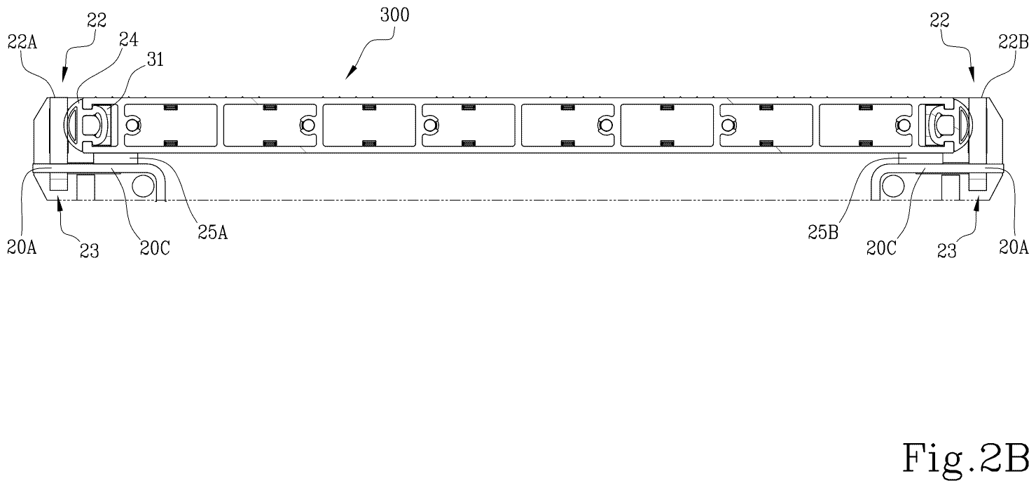

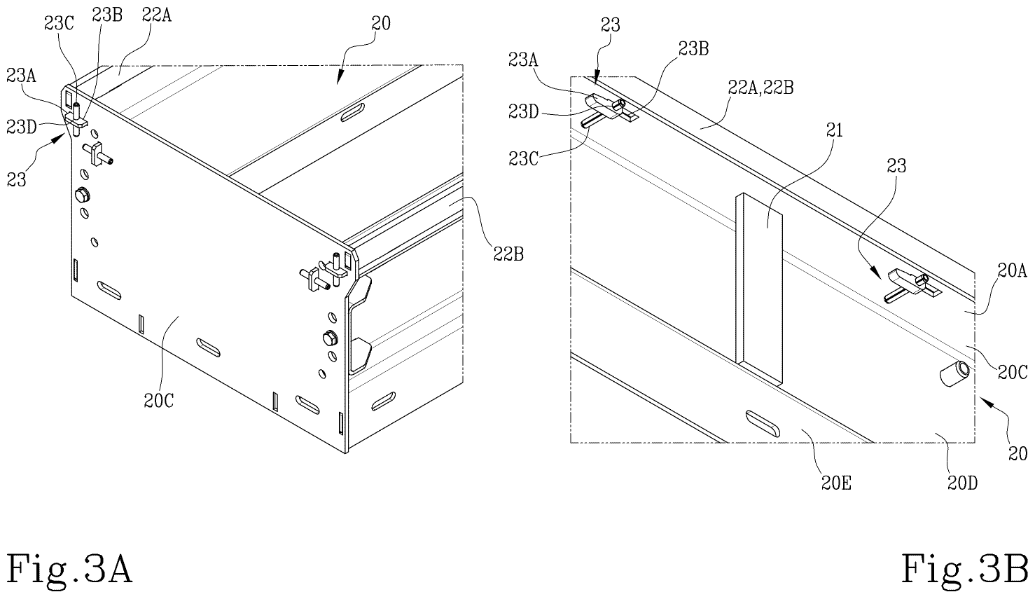

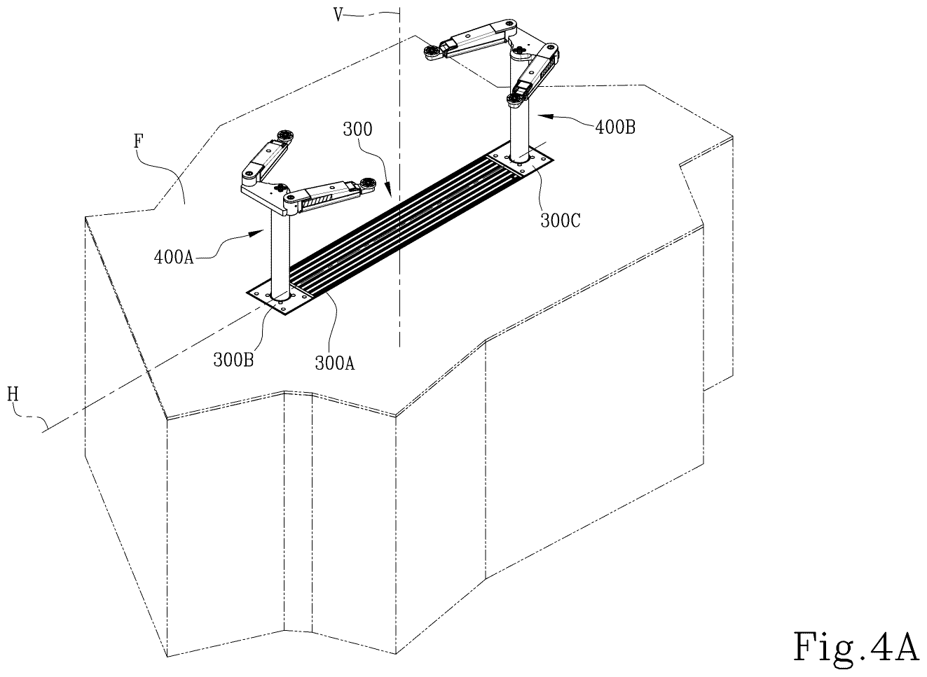

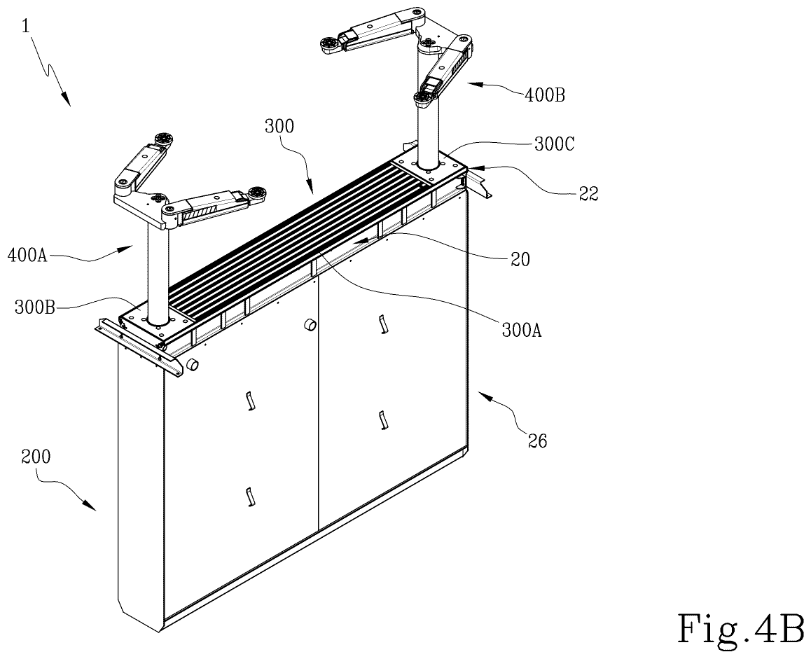

### DESCRIPTION OF EXAMPLE EMBODIMENTS

With reference to the accompanying drawings, the numeral 1 denotes an underfloor lifting platform for lifting vehicles along a vertical direction V.

The underfloor lifting platform 1 comprises a canister 200. The canister 200 is configured to be arranged underground to define an inground environment. The underfloor lifting platform 1 comprises a plate 300 couplable with the canister 200 so to close the inground environment from the outside environment. In particular, the plate 300 is coupled with the canister 200 to be flush with the floor 2. The underfloor lifting platform 1 comprises a first cylinder piston unit 400A and a second cylinder piston unit 400B that are arranged within the canister 200 and movable along the vertical direction V so to lift the vehicle along the vertical direction V. The canister 200 includes a body 20 surrounding the inground environment. The body has a first sidewall 20′ and a second sidewall 20″ defining a pair of sidewalls. Each of the sidewalls 20 and 20″ extends in the vertical direction V between a first edge 20A proximal to the plate 300 and a second edge 20B, opposite to the first edge 20A. Each sidewall 20′ and 20″ defines a bended profile from the first edge 20A and the second edge 20B; the bended profile has a first portion 20C protruding towards a central area (i.e. the inground environment) of the body 200 along an horizontal direction H perpendicular to the vertical direction V. The first portion 20C defines a supporting surface for the plate 300 so that when the plate 300 is coupled to the canister 200, the plate 300 lays along the horizontal direction H. The first portion 20C is contiguous to the first edge 20A and the first portion 20C and the first edge 20A lay along the same plane (i.e. the plane defined by the horizontal direction H). The bended profile includes a second portion 20D protruding from the first portion 20C and extending in the vertical direction V towards the second edge 20B. The bended profile includes a third portion 20E protruding from the second portion 20D along the horizontal direction H away from the central area of the body 20 so that the third portion 20E and first portion 20C are parallel to each other. In an embodiment, the canister 200 has a plurality of reinforcement elements 21, located outside of the inground environment, between the first portion 20C and the third portion 20E and parallel to the second portion 20D so to support the first and the second sidewalls 20′ 20″.

The canister 200 includes a frame 22 made of stainless steel and having a first elongated portion 22A, a second elongated portion 22B (defining a pair of elongated portions), a first panel 22C and a second panel 22D (defining a pair of panels). The first elongated portion 22A is connected at the first edge 20A of the first sidewall 20′ and the second elongated portion 22B is connected at the first edge 20A of the second sidewall 20″. At an end, the first elongated portion 22A and the second elongated portion 22B are connected to the first panel 22C, at the other end the first elongated portion 22A and the second elongated portion 22B are connected to the second panel 22D. The first panel 22C is connected to the first sidewall 20′ and to the second sidewall 20″ at an end of the sidewalls and the second panel 22D is connected to the first sidewall 20′ and to the second sidewall 20″ at the opposite end of the sidewalls, so to form a rectangular-shaped box. The plate 300, when supported by the supporting surface (i.e. the first portion 20C) of the body 20, is surrounded by the first elongated portion 22A, the second elongated portion 22B, the first panel 22C and the second panel 22D. In particular, the first elongated portion 22A, the second elongated portion 22B, the first panel 22C and the second panel 22D define an outer perimeter of the frame 22 that is visible from the outside environment.

The canister 200 includes a plug system 23. The plug system 23 is configured for removably connecting together the frame 22 and the body together 20. In particular, the plug system 23 includes a plurality of connecting protrusions 23A and a plurality of corresponding connecting holes 23B, configured for engaging with each other so that when connecting the frame 22 and the body 20 together, a connecting protrusion 23A enters in a connecting hole 23B. In particular, the elongated portions 22A and 22B are provided with a group of connecting protrusions 23B that are hooked-shaped. The sidewalls 20′ and 20″, in correspondence of the first edge 20A are provided with a corresponding group of connecting holes 23B, configured for engaging with the connecting protrusions 23A of the elongated portions 22A. The plug system 23 has a plurality of pins 23C. Some connecting protrusions 23B (for example some of the ones provided in the elongated portions 22A and 22B) are provided with a hole 23D so that when the connecting protrusion 23B engages with the corresponding connecting hole 23B, the pin 23C is inserted within the hole 23D to block the frame 22 to the body 20. The sidewalls 20′ and 20″ are provided with connecting protrusions 23A as well, configured for engaging with correcting holes 23B provided at the panels 22C and 22D.

The plate 300 plate has a recess 31 which runs along a perimeter of the plate 300. The canister 200 comprises a gasket 24 running along a perimeter of the plate 300, located inside the recess 31 in contact with the elongated portions 22A and 22B of the frame 22, so to seal a gap between the plate 300 and the frame 22.

In particular, the plate 300 has a central plate 30A and a first and a second side plates 30B 30C so that when the plate 300 is coupled with the canister 200 the central plate 30A is located between the first side plate 30B and the second side plate 30C. The first and the second side plates 30B 30C are located in correspondence of the first and of the second cylinder piston units 400A and 400B. Preferably, the recess 31 is provided in the central plate 30A and the gasket 24 is located inside the recess 31 in contact with the elongated portions 22A and 22B of the frame 22, so to seal a gap between the central plate 300 and the frame 22.

In the illustrated examples, the canister 200 includes a first strip 25A and a second strip 25B; the first strip 25A is located between the plate 300 (the central plate 30A) and the first portion 20C of the first sidewall 20′ of the body 20, while the second strip 25B is located between the plate 300 (the central plate 30A) and the first portion 20C of the second sidewall 20″ of the body 20. The first strip 25A and the second strip 25B can be configured for sealing a gap between the plate 300 (the central plate 30A) and the first portions 20C. The first strip 25A and the second strip 25B can be made of a plastic material (for example, of polyethylene). The first strip 25A and the second strip 25B have, for example, a width (in the vertical direction) of 5 mm; they elongate in the horizontal direction, preferably to the whole length of central plate 30A (for example 1190 mm); transversally to the horizontal direction (and perpendicularly to the vertical direction), they have the size for example of 20 mm.

The canister 200 includes a base structure 26. The base structure 26 is box-shaped and comprises an aperture that is connected to the body 20 at the second edge 20B of the body 20. In particular, the base structure 26 is connected to the first sidewall 20′ and to the second sidewall 20″ at the second edge 20B, and to the first panel 22C and to the second panel 22D of the frame 22.

When assembling the underfloor lifting platform 1, first, the body 20 covered with a layer of galvanized material by a hot-dip galvanization of the body 20. Then, the body 20 can be connected to the frame 22, that is made of stainless steel, through the plug system 23.

1. An underfloor lifting platform for lifting vehicles, comprising:
a canister, configured to be arranged underground to define an inground environment;
a plate, couplable with the canister so to close the inground environment and to be flush with the floor;
a first and a second cylinder piston units, operatively arranged within the canister and being movable along a vertical direction;
wherein the canister includes:
a body, surrounding the inground environment, extending in the vertical direction between a first edge, proximal to the plate, and a second edge, opposite to the first edge, and defining a supporting surface for supporting the plate;
a frame, made of stainless steel, connected to the body at the first edge of the body, the frame having an outer perimeter that is flush with the floor and surrounds the plate,
the underfloor lifting platform being characterized in that the frame is removably connected to the body through a plug system.

2. The underfloor lifting platform according to claim 1, wherein the body comprises a layer of hot-dip galvanized material.

3. The underfloor lifting platform according to claim 2, wherein the layer of hot-dip galvanized material has a thickness of at least 50 μm.

4. The underfloor lifting platform according to claim 1, wherein the plug system includes a plurality of connecting protrusions and a plurality of corresponding connecting holes configured for engaging with each other so to connect the body and the frame together.

5. The underfloor lifting platform according to claim 4, wherein:
each connecting protrusion of the plurality of connecting protrusions is hook-shaped and has a hole;
the plug system includes a plurality of pins, each pin being configured to engage with the hole of a corresponding connecting protrusion so to block the frame and the body together when the connecting protrusion (23A) is inserted in the corresponding connecting hole.

6. The underfloor lifting platform according to claim 1, wherein:
the body includes a pair of sidewalls, extending along a horizontal direction perpendicular to the vertical direction and being opposite to each other, and
the frame includes a pair of panels, opposite to each other and removably connected by shape coupling to the pair of sidewalls of the body, so to define, together with the pair of sidewalls, a rectangular shaped-box.

7. The underfloor lifting platform according to claim 6, wherein the frame includes a pair of elongated portions, extending along the horizontal direction, each elongated portions of the pair of elongated portions being connected at the first edge with a respective sidewalls of the pair of sidewalls of the body, the pair of elongated portions being connected to the pair of panels so that the outer perimeter is defined by the pair of elongated portions and the pair of panels flush with the floor.

8. The underfloor lifting platform according to claim 6, wherein each of the sidewalls develops from the first edge to the second edge so to define a bended profile having a first portion protruding towards a central area of the body along the horizontal direction, the first portion defining the supporting surface for the plate.

9. Method for producing an underfloor lifting platform for lifting vehicles, comprising the following steps:
providing a canister, arranged underground to define an inground environment;
providing a plate, coupled to the canister so to close the inground environment and to be flush with the floor;
providing a first and a second cylinder piston units, operatively arranged within the canister and being movable along a vertical direction,
providing a body for the canister, surrounding the inground environment, extending in the vertical direction between a first edge, proximal to the plate, and a second edge, opposite to the first edge, and defining a supporting surface for supporting the plate;
providing a frame for the canister, made of stainless steel;
connecting the frame to the body at the first edge of the body, the frame having an outer perimeter that is flush with the floor and surrounds the plate,
the method being characterized in that the frame is removably connected the body through a plug system.

10. The method of claim 9, comprising a step of hot dipping the body with a layer of galvanized material.

11. The method of claim 10, wherein the step of dipping the body is completed before the step of connecting the frame to the body.

12. The method of claim 9, wherein the plug system includes:
a plurality of connecting protrusions and a plurality of corresponding connecting holes configured for engaging with each other so to connect the body and the frame together, each connecting protrusion of the plurality of connecting protrusions being hook-shaped and having an hole, and
a plurality of pins, each pin being configured to engage with the hole of a corresponding connecting protrusion so to block the frame and the body together when the connecting protrusion is inserted in the corresponding connecting hole.

13. The method of claim 9, wherein:
the body includes a pair of sidewalls, extending along a horizontal direction perpendicular to the vertical direction and being opposite to each other, and
the frame includes a pair of panels, opposite to each other,
the method comprising a step of removably connecting the pair of panels to the pair of sidewalls of the body by shape coupling, so to define, together with the pair of sidewalls, a rectangular shaped-box.

14. The method according to claim 13, wherein the frame includes a pair of elongated portions, extending along the horizontal direction, and the method comprises the following steps:
connecting each elongated portions of the pair of elongated portions with a respective sidewall of the pair of sidewalls of the body, and
connecting the pair of elongated portions to the pair of panels so that the outer perimeter is defined by the pair of elongated portions and the pair of panels are flush with the floor.

15. The method according to claim 13, wherein each of the sidewalls develops from the first edge to the second edge so to define a bended profile having a first portion protruding towards a central area of the body along the horizontal direction, the first portion defining the supporting surface for the plate.

16. The underfloor lifting platform according to claim 2, wherein the thickness of the layer of hot-dip galvanized materal is lower than 150 μm.

17. The underfloor lifting platform according to claim 7, comprising a gasket, configured for sealing a gap between the elongated portions of the frame and the plate and a gap between the panels of the frame and the plate.

18. The underfloor lifting platform according to claim 17, wherein the plate has a recess running along a perimeter of the plate and configured for receiving a portion of the gasket so that the gasket, inserted in the recess and in contact with the frame, is configured for sealing a gap between the plate and the frame.

19. The underfloor lifting platform according to claim 8, wherein the canister includes a first strip and a second strip, the first strip being located between the plate and the first portion of a first sidewall of the body, the second strip being located between the plate and the first portion of a second sidewall of the body.

20. The underfloor lifting platform according to claim 19, wherein the first strip and the second strip are made of plastic material.
